(19) United States
(12) Patent Application Publication
(10) Pub. No.: US 2024/0028418 A1
(43) Pub. Date: Jan. 25, 2024

(54) CROSS-CLOUD RESOURCE MOBILITY OPTIMIZATION

(71) Applicant: Dell Products, L.P., Round Rock, TX (US)

(72) Inventors: Kristen Walsh, Austin, TX (US); Sumedh Sathaye, Austin, TX (US)

(21) Appl. No.: 17/868,716

(22) Filed: Jul. 19, 2022

(51) Int. Cl. G06F 9/50; G06F 9/48

(52) U.S. Cl. CPC G06F 9/5083; G06F 9/4875

(57) ABSTRACT

Metrics, including cost and latency, corresponding to public computing system are monitored. A determination to migrate a workload running at a donor computing system may be made based on the monitored metrics. Before migrating the workload, state information corresponding to the workload may be stored to a remote storage that stores data used by the workload, but that is not part of the public computing systems. The recipient computing system may be instructed to retrieve the state information from the remote storage and to revive the workload based on the retrieved state information. The state information may comprise parameter values and factors that were current when the state information was stored. The state information may comprise an image of the workload. The recipient system may be instructed to revive the workload based on the retrieved state information retrieved from the remote storage.

### BACKGROUND

The term ‘cloud’ may refer to a set, group, collection, or other plurality of computing resources, components, services, instances, collections, application, and the like that may be accessed by a computing resource, typically via a communication network (a communication network may also be referred to as a cloud). The term ‘cloud’ is typically used in reference to the computing resources without referencing specific items that make up the cloud resources when discussing computing functionality from the perspective of a computing resource that may make use of the functionality.

A cloud computing service provider may make available various computing resources as a service, for example, software, virtual machines, storage, bare metal computing hardware, or even a complete enterprise's infrastructure and development platforms, over a communication network. A cloud service provider may make a public cloud computing resource available to users over a publicly accessible network, such as the Internet. A private cloud computing resource is typically available or accessible only by a given customer, such as an enterprise and its employees. Computing resources may be provided from an enterprise's own on-premises data center or from a data center operated by an independent (e.g., independent from the enterprise customer) cloud services provider. A hybrid cloud may connect an organization's private cloud services and resources of public clouds into an infrastructure that facilitates the organization's applications and workloads in a manner that balances the maximizing of performance and the minimizing of costs across public and private cloud computing resources.

Cloud providers, whether providers of public or private computing resources, may use clustering of servers. A server cluster typically comprises servers that share a single Internet Protocol (“IP”) address. Clustering enhances data protection typically, availability, load balancing, and scalability. A server associated with a cluster may be referred to as a node, which may comprise a hard drive, random access memory, (“RAM”), and central processing unit (“CPU”) resources. In a hybrid cloud environment it is desirable for an organization to use resources of its private cloud as much as possible and use public cloud computing resources to handle spikes in usage demands that would exceed a determined limit, or a capacity, of the organization's private network. Moreover, it is desirable for an organization to optimize (e.g., minimize) costs related to use of public cloud resources. An organization's private cloud computing system, or systems, may comprise active components, modules, storage, services, and other resources that facilitate computing needs of the enterprise. An organization's private cloud computing resources may also comprise idle, or inactive, components, modules, storage, services, and other resources that are essentially held in reserve but are not used until workload increases require additional resources than the active resources already being used and paid for by the enterprise. The enterprise may subscribe to the computing resources of their private network from a computing resources provider/cloud computing provider instead of maintaining the resources and owning them outright. A provider may increase a subscription fee when an enterprise activates idle/inactive resources. The subscription may include a warranty cost associated with given active computing resources, such as storage, a processing components or instances, network bandwidth, and the like. Typically, the more a resource has been used, the more ‘wear’ has been placed on it. Thus, an organization desires to find an optimal balance of use of private and public cloud resources to maximize performance and to facilitate supporting computing workloads of the organization while minimizing costs for computing resources and services whether public or private.

An organization may have multiple providers of public computing resources (e.g., multiple providers of public cloud computing resources) to choose from in handling its workloads for which it uses public cloud resources. Pricing from one public computing provider for a given service may be less that pricing for the same service from another provider, but the pricing between the two providers may change with the previously more costly provider becoming the lower cost provider. However, costs to switch providers, especially costs to transfer large volume of data from one provider to another is prohibitively high.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

In an example embodiment, an example method may comprise monitoring, via a communication network, such as the Internet, by a first computing system comprising a processor, at least one metric corresponding to at least one of a group of computing systems that are coupled with, and that provide computing services via, the communication network. The first computing system may comprise an organization's private network, which may be operated by the organization at its own data center or may be operated for the organization at a data center that is not operated by the organization. The at least one metric may comprise cost, latency, or other information related to use by the organization of the at least one of the group of computing systems, which group may comprise public computing systems that the organization may use, or be able to use, to operate workloads instead of operating the workloads on their private computing system. The method may comprise analyzing, by the first computing system, the at least one metric with respect to a determined migration criterion, and in response to the at least one metric being determined to satisfy the determined migration criterion based on a result of the analyzing, initiating, by the first computing system, a migrating of a computing workload from a second computing system of the group of computing systems to a third computing system of the group of computing systems.

The determined migration criterion may comprise a cost element, or factor; a latency element, or factor; an amount of time for the migration to occur after initiation; and the like. For example, the migration criterion may be used to determine to migrate the workload to a third computing system that has a lower cost to the organization for operating the workload than is currently being paid by the organization to a provider of the second computing system. However, in an aspect, the criteria could also seek to optimize operating of the workload by one of the group of computing systems according to cost as well as latency. In a scenario, a given computing system of the group of computing systems may provide a lower operating cost for handling the workload than the currently used second computing system but if a latency value of a monitored metric associated with the given computing system is significantly higher than a latency associated with the currently used second computing system the migration criterion, or criteria, may not be satisfied. In other words, in the example scenario, using the migration criterion, or criteria, a determination may be made that an increase in latency may not be worth the reduced cost to the organization that corresponds to the workload.

The example method may further comprise storing pre-migration state information corresponding to a state of the workload at the initiating of the migrating of the workload to a remote computing system storage, which may be remote from the first computing system, the second computing system, and the third computing system; and causing the reviving of the workload at the second computing system with the pre-migration state information. The pre-migration state information may correspond to a ‘dirty state’ that corresponds to a state of the workload at the time of the initiating. The ‘dirty-state’ pre-migration state information may include parameter values, coefficients, factors, connection information, metadata, user log-in information, and other data produced by, used by, stored by, or otherwise associated with the workload at the time of the initiating, but may not include a complete copy of the full workload (e.g., the pre-migration state information may not include application code for running a workload virtual machine). In other words, code to start a new workload may not be part of the pre-migrations state information stored to the remote computing system storage, but the pre-migration state information may include information that may be used to configure a new workload virtual machine that is started at the third computing system such that the new workload virtual machine is operating on the third computing system as the previous workload was operating on the second computing system at the time of the initiating of the migration. The computing workload may comprise a computing instance, which may comprise a virtual machine. The computing workload may comprise an application. A workload may comprise an instance of a solution created to solve a problem, by using, configuring, or connecting multiple services offered by a cloud services provider, which may provide services corresponding to a public cloud or services corresponding to a private cloud. A set of services provided by a cloud services provider may comprise, for example, bare-metal computing resources as a service, virtual machine as a service, database as a service, identity as a service, to name a few. A typical cloud services provider may offer hundreds of computer-related services. Embodiments disclosed herein may enable or facilitate movement of one instance of a solution in one cloud to another cloud, which clouds, or corresponding cloud services, may be operated or provided by different services providers or by the same services provider.

The computing workload may be configured to access, and perform operations on, data that is stored by a storage of a fourth computing system that is coupled with the communication network, wherein the fourth computing system comprises the remote computing storage on which the pre-migration state information is stored. For example, the remote computing storage may comprise a storage located geographically close to a location of one or more of the group of computing systems that facilitates storage of data of the organization such that the data need not be migrated with the migration of a workload from one public computing system to another.

The determined migration criterion may be determined according to rules and/or factors. An individual user, such as an employee of the organization, may determine the rules or factors. For example, the rules or factors may be determined to always minimize cost to operate a workload. In another example, the rules or factors may be determined to minimize costs to operate the workload as long as latency in a computing system that a workload is migrated to, such as the third computing system, does not exceed a limit. An artificial intelligence algorithm may determine the criterion, or criteria, based on analyzing past migration activity when cost or latency metrics were considered and based on cost savings or latency changes achieved based on the past analyzing.

The rules and factors may be determined based on user input received by the first computing system, wherein the user input comprises information corresponding to the rules and factors entered or provided via an interface coupled with the first computing system.

The method may further comprise determining, by the first computing system, the rules and factors based on a log of migration operations performed by the first computing system before the analyzing of the at least one metric with respect to the determined migration criterion. An artificial intelligence model algorithm may have been trained using log, or history, information corresponding to previous migration activities, which may include having determined not to perform a migration if monitored metrics did not satisfy a migration criterion, or migration criteria. Thus, the artificial intelligence model algorithm may be trained not only on migration activities that were performed in the past along with corresponding past actual cost or latency improvements or degradations, but the artificial intelligence model algorithm may also be trained on past actual cost or latency improvements or degradations that occurred after monitored metrics were analyzed but a determination was made not to migrate a workload from a public computing system currently being used to another public computing system.

The at least one metric may comprise a spot market cost factor applicable to operation of the computing resource on the second computing system. A spot market may comprise an online, or electronic, platform operated for sellers that may currently use, or that may have purchased the right to use, computing resources of one or more public computing system providers—the sellers may effectively become resellers of public computing resources. Instead of using the computing system resources that have been purchased, the sellers may choose to sell the resources. The spot market may be in the form of an auction available to, or may be in the form of a direct offer from a seller to, an organization's private computing system, or a module that monitors metrics or that determines to migrate a workload. The module may monitor cost or latency metrics from a seller/reseller via the Internet and may automatically determine to migrate a workload based on analyzing of the monitored metrics from the spot market being analyzed according to the migration criterion/criteria.

The first computing system may output, via a user interface of the first computing system, an alert that the at least one metric has been determined to satisfy the determined migration criterion. An alert may be intended to notify personnel of the organization that a determination has been made by a module that has analyzed monitored metric data according to migration criterion/criteria. An alert may comprise a query that requests an approval input from an organization's personnel via a user interface that the migration may proceed, or the alert may merely inform an organization, personnel thereof, or just a module of a private computing system of an organization, that a determination has been made to migrate a workload.

In an example embodiment, an example system may comprise a first computing system, coupled to a communication network, that may comprise a processor configured to monitor, via the communication network, at least one metric corresponding to at least one computing system of computing systems that are coupled to, and that enable computing services via, the communication network. The computing systems of which the one computing system is a member, may comprise a public computing system to which an organization may migrate a workload. The processor may be configured to analyze the at least one metric with respect to a determined migration criterion; and in response to the at least one metric being determined to satisfy the determined migration criterion based on a result of the analyzing, initiate migration of a computing workload from a second computing system of the computing systems to a third computing system of the computing systems.

The processor may be further configured to store pre-migration state information corresponding to a state of the workload at the initiating of the migrating of the workload to a remote computing system storage that is remote from the first computing system, the second computing system, and the third computing system; and to cause the reviving of the workload at the second computing system with the pre-migration state information. The causing of the reviving of the workload may comprise sending a message to the remote computing system storage with an instruction to forward, or to permit the retrieval of, the pre-migration information to the third computing system to which the workload is being migrated. The pre-migration state information may comprise dirty state values that can be used to configure a new virtual machine at the third computing system or the pre-migration state information may comprise a full image of the workload before, or at the time of, the initiating of the migration of the workload.

The workload may be configured to access, or perform operations on, or process, an enterprise's data, which may be referred to as operational data or enterprise data, that is stored by a storage of a fourth computing system that is communicatively coupled with the communication network, and wherein the fourth computing system comprises the remote computing storage on which the pre-migration state information is stored. The enterprise's operational data that may be stored by the storage of the fourth computing system may comprise data that is not the pre-migration data. The enterprise's operational data may comprise databases, video content files, image content files, text content files, and other types of data. The enterprise's operational data may correspond to amounts or sizes of data such that if the operational data had to be migrated with a workload, such migration of the workload would likely not be cost beneficial to the organization corresponds to the workload if a cost associated with transferring the enterprise's operational data from a current computing system on which the workload is currently operating to a computing system to which the workload is to be migrated would exceed cost saving that might otherwise be realized by migrating the workload. Thus, the pre-migration state information may be stored to the same storage on which operational data that the workload uses is stored.

The determined migration criterion may be determined according to rules and factors. The processor may be further configured to present a user interface to receive one or more inputs from a user to determine the rules and factors or to enter the migration criterion or migration criteria. The processor may be further configured to determine the rules and factors based on a log of migration operations performed by the first computing system before the analyzing of the metric with respect to the determined migration criterion.

In an example embodiment, a non-transitory machine-readable medium may comprise executable instructions that, when executed by a processor of a computing device coupled with a communication network, facilitate performance of operations, comprising: monitor, via the communication network, at least one metric corresponding to at least one of a set of computing systems that are coupled with the communication network; analyze the at least one metric with respect to a determined migration criterion; and in response to the at least one metric being determined to satisfy the determined migration criterion based on a result of the analyzing, initiate migration of a computing workload from a second computing system of the set of computing systems to a third computing system of the set of computing systems.

The processor may be further configured to store pre-migration state information corresponding to a state of the workload at the initiating of the migrating of the workload to a remote computing system storage that is remote from the first computing system, the second computing system, and the third computing system; and cause the reviving of the workload at the second computing system with the pre-migration state information.

The workload may be configured to access, and perform operations on, data, such as an enterprise's operational data, that is stored by a storage of a fourth computing system that is coupled with the communication network and that may be geographically located within a defined distance of the second computing system, and wherein the fourth computing system may comprise the remote computing storage on which the pre-migration state information is stored. The pre-migration state information may comprise an image of the workload. The pre-migration state information may comprise state information corresponding to the workload at the initiating of the migration of the workload but not an image of the full workload at the initiating of the migration.

### BRIEF DESCRIPTION OF THE DRAWINGS

FIG. 1 illustrates an example hybrid computing system with a plurality of public computing systems.

FIG. 2A illustrates an example hybrid computing system showing a workload at the beginning of migration from a public computing system to a different public computing system.

FIG. 2B illustrates an example hybrid computing system showing a workload during migration from a public computing system to a different public computing system.

FIG. 2C illustrates an example hybrid computing system showing a workload after migration from a public computing system to a different public computing system.

FIG. 3A illustrates an example embodiment system to migrate a full workload from a public computing system to a different public computing system.

FIG. 3B illustrates an example embodiment system to perform a dirty state migration of a workload from a public computing system to a different public computing system.

FIG. 3C illustrates an example embodiment system to perform an image migration of a workload from a public computing system to a different public computing system.

FIG. 4 illustrates an embodiment system having a module to facilitate migration of a workload from a public computing system to a different public computing system.

FIG. 5 illustrates a flow diagram of an example method to migrate a workload from a public computing system to a different public computing system.

FIG. 6 illustrates a flow diagram of an example method to facilitate performing different types of migration of a workload from a public computing system to a different public computing system.

FIG. 7 illustrates a computer environment.

FIG. 8 illustrates a block diagram of an example method.

FIG. 9 illustrates a block diagram of an example system.

FIG. 10 illustrates a block diagram of an example non-transitory machine-readable medium.

### DETAILED DESCRIPTION OF THE DRAWINGS

As a preliminary matter, it will be readily understood by those persons skilled in the art that the present embodiments are susceptible of broad utility and application. Many methods, embodiments, and adaptations of the present application other than those herein described as well as many variations, modifications and equivalent arrangements, will be apparent from or reasonably suggested by the substance or scope of the various embodiments of the present application.

Accordingly, while the present application has been described herein in detail in relation to various embodiments, it is to be understood that this disclosure is illustrative of one or more concepts expressed by the various example embodiments and is made merely for the purposes of providing a full and enabling disclosure. The following disclosure is not intended nor is to be construed to limit the present application or otherwise exclude any such other embodiments, adaptations, variations, modifications and equivalent arrangements, the present embodiments described herein being limited only by the claims appended hereto and the equivalents thereof.

As used in this disclosure, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

The term “facilitate” as used herein is in the context of a system, device or component “facilitating” one or more actions or operations, in respect of the nature of complex computing environments in which multiple components and/or multiple devices can be involved in some computing operations. Non-limiting examples of actions that may or may not involve multiple components and/or multiple devices comprise transmitting or receiving data, establishing a connection between devices, determining intermediate results toward obtaining a result, etc. In this regard, a computing device or component can facilitate an operation by playing any part in accomplishing the operation. When operations of a component are described herein, it is thus to be understood that where the operations are described as facilitated by the component, the operations can be optionally completed with the cooperation of one or more other computing devices or components, such as, but not limited to, sensors, antennae, audio and/or visual output devices, other devices, etc.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable (or machine-readable) device or computer-readable (or machine-readable) storage/communications media. For example, computer readable storage media can comprise, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

A monitor service may monitor components, resources, or workloads in a hybrid computing system environment. The monitor service can run on a SmartNIC or iDRAC or iSM or VxRail Manager or OpenBMC or any such controller of the computing system. The monitoring service may be one of multiple monitoring service with some of the services acting as clients of a master of the monitoring services, which master may act as a main interface for the others with respect to the computing system, such as may be used in a computing environment that comprises clusters.

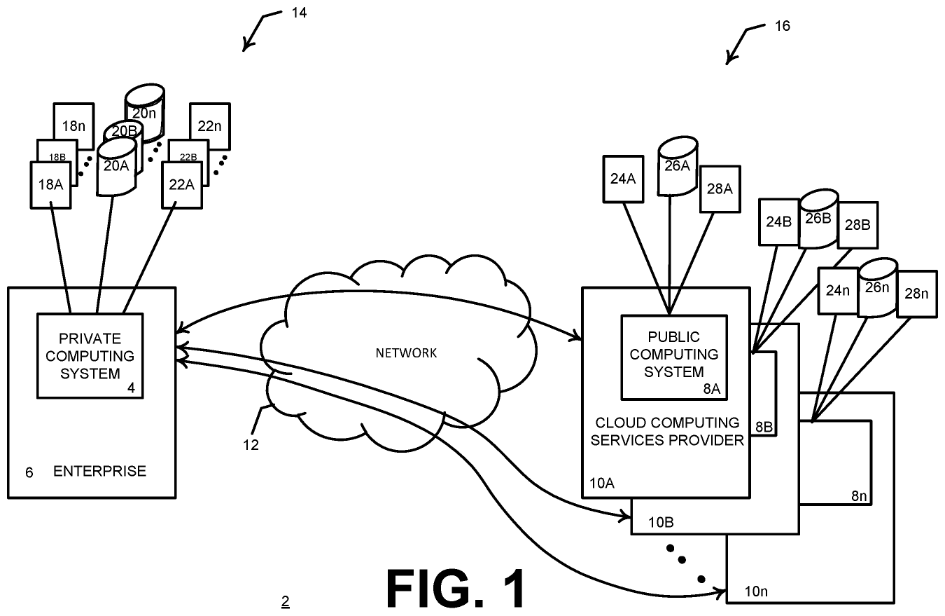

Turning now to the figures, FIG. 1 illustrates computing system 2, which may comprise a hybrid computing system. System 2 may comprise private computing system 4 operated by an enterprise 6, which may be a business, a learning institution, a government agency, and the like. Private computing system 4 may communicate with one or more public computing systems 8A-8n, which may be operated by corresponding cloud computing services providers 10A-10n, via communication network 12, which may comprise the Internet. Private computing system 4 may comprise a plurality of computing resources, for example processing resources 18A-18n, storage resources 20A-20n, and software resources 22A-22n. Private computing system 4 may comprise other resources than processing, storage, and software, which are shown only for purposes of illustration and discussion. Public computing systems 8A-8n may comprise a plurality of computing resources, for example processing resources 24A-24n, storage resources 26A-26n, and software resources 28A-28n. Public computing systems 8A+8n may comprise other resources than processing, storage, and software, which are shown only for purposes of illustration and discussion.

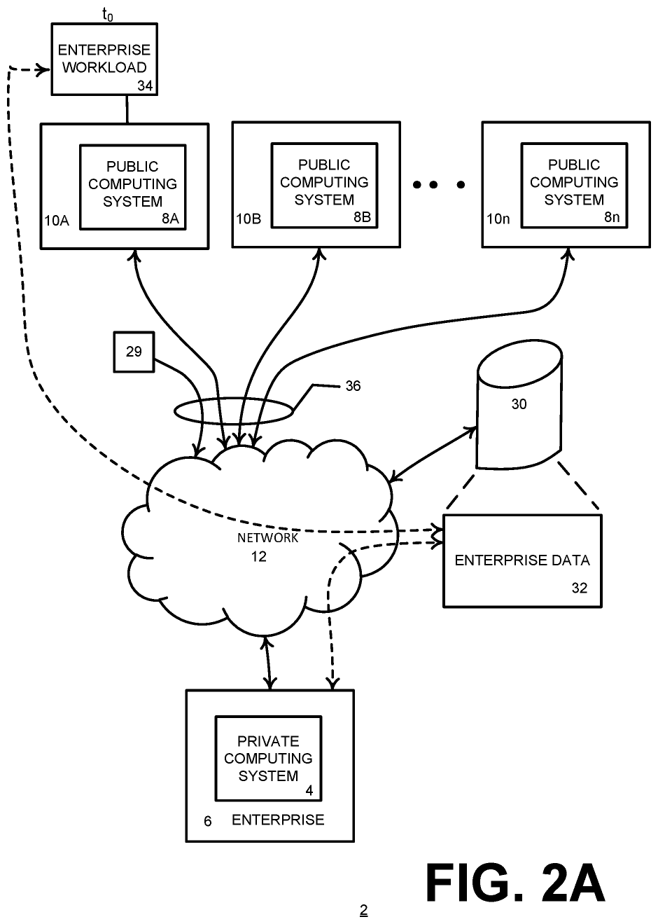

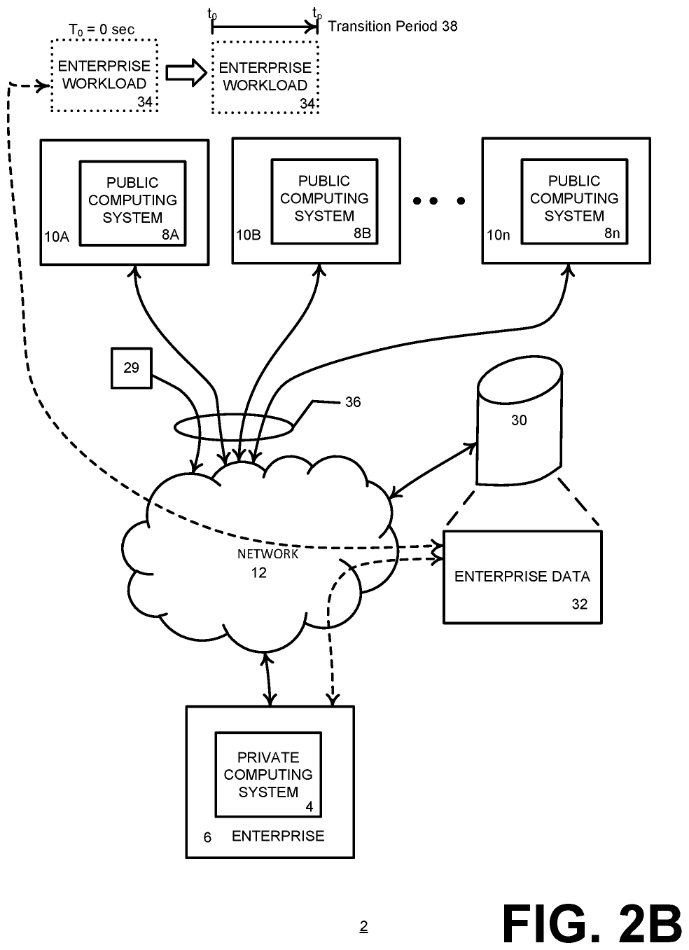

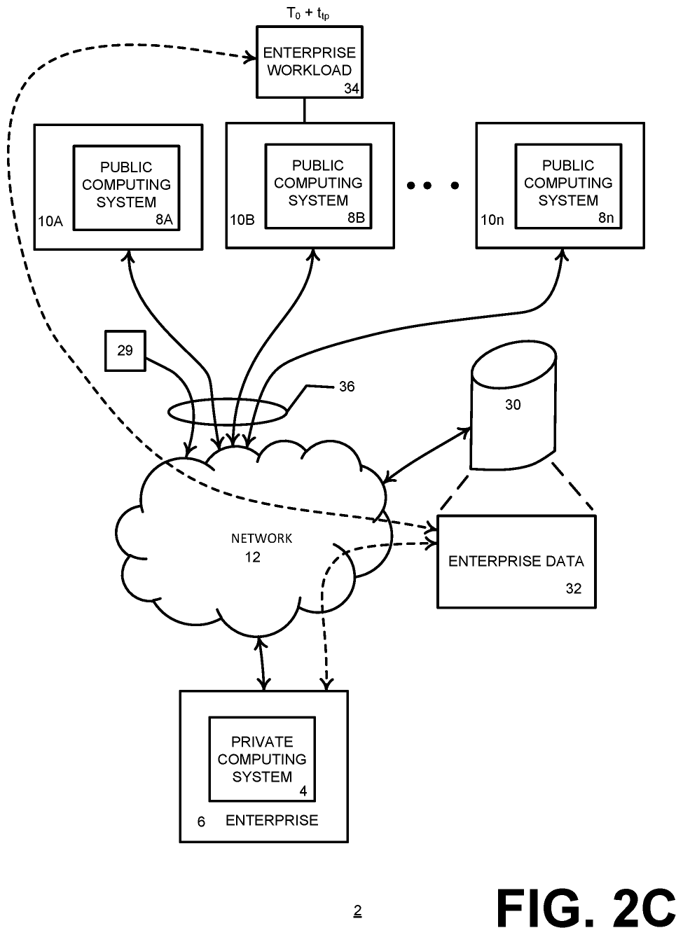

Turning now to FIG. 2A, the figure illustrates system 2 with monitor 36, which monitors usage parameters corresponding to public computing system resources 8A-8n of public computing service providers 10A-10n. The monitored parameters may comprise pricing for one or more different computing resources of computing systems 8A-8n of providers 10A-10n. The pricing information may be received via communication network 12. In addition to receiving pricing information for various computing services from service providers 10A-10n, pricing for services offered by providers 10A-10n may be received via communication network 12 from resellers, or from one or more spot market providers 29 that facilitate a market, including online, Internet or other electronic market type, for buying and selling public computing resources that have already been sold by providers 10A-10n. Monitor 36 may comprise one or more computing services. In an embodiment, monitor 36 may comprise a service running on private computing system 4. Monitor 36 may comprise a service running on a third computing system coupled with communication network 12 that is not private computing system 4 or one of public computing systems 8A-8n, or the monitor may comprise a service running on one of public computing systems 8A-8n.

Storage 30 may comprise storage resources, such as disc drives, solid state drives, tape drives, and the like, that are provided by a storage resources provider that is not one or public computing resource providers 10A-10n. Storage 30 may be collocated at a computing data center that is operated for one of public computing resource providers 10A-10n. Storage 30 may be located at a computing data center that is not operated by one of public computing resource providers 10A-10n, but that is located geographically close to a data center operated by one of providers 10A-10n. Storage 30 may facilitate an enterprise storing its enterprise information and operational data 32 separate from computing resources provided by public computing resource providers 10A-10n. If enterprise 6, or the enterprise's computing system 4, determines to change from one of providers 10A-10n to another of providers 10A-10n for the providing of computing resources that augment private computing system 4, data 32 does not have to be transferred from the one public computing resources provider to the other.

Data egress may refer to moving, or transferring, data from one storage to another, including from a storage of one public computing resources provider to another public computing resources provider, or more generally, date egress may refer to the movement from a computing system or from a computing component to another computing system, or component thereof. Data egress costs from public cloud computing systems are usually high, not only in terms of time to reserve space at a target storage but also in terms of the actual time to transfer data from one storage to another, as well as in terms of bandwidth resources of a communication network used to transfer the data. The cost associated with moving data from one storage to another when a user, such as enterprise 6, switches providers from one public computing resources provider to another may be prohibitively high insofar as any cost saving an organization my otherwise realize by changing public computing resources providers because differences in computing services pricing may be overwhelmed by data transfer, or data egress, costs. Thus, an organization may keep its data with the public computing provider even though the organization may be able to obtain better pricing with another provider. By an organization, such as enterprise 6, storing its data 32 at third-party storage facility 30 (the storage is operated by a ‘third-party’ in the sense that storage 30 is not part of public computing systems 8A-8n) the organization may change providers of computing resources dynamically, or almost ‘on-the-fly’, because data 32 stays at storage 30 and thus data egress costs are reduced, if not eliminated.

FIG. 2A shows workload 34 of enterprise 6 being currently (e.g., at time t₀ seconds) serviced by resources of public computing system 8A provided by provider 10A. The term ‘workload’ may refer to a computing application, service, instance, capability, or work that consumes computing resources (e.g., processing, memory, network access, or storage). Databases, tables, containers, microservices, VMs, bare-metal computing resources, including bare-metal computing resource configurations, which bare-metal resources may be offered as a service, and the like may be referred to as workloads. Workloads may comprise mobility solutions, office productivity applications, video conferencing solutions, disaster recovery solutions, analytics, or web content/hosting. Workload 34 is rendered in FIG. 2A in solid lines to show that the workload is currently being services by computing system 8A. Workload 34 may be facilitated by containerized services, instances, applications, and the like that may be migrated, partially or fully, from one or more virtual machines (“VM”) running on computing system 8A to one or more VMs running on any other system, or systems, 8B-8n.

Turning now to FIG. 2B, workload 34 is shown in broken lines at to and again in broken lines between to and a time after to that is to plus a transition period tₚ 38. The phrase ‘migration period’ may be used to refer to transition period 38. Workload 34 is shown unattached to a computing system 8A-8n in FIG. 2B. The transition, or migration, of workload 34 from computing system 8A may have been determined to proceed because of computing system 4 electronically receiving pricing information corresponding to one or more of computing systems 8B-8n from monitor 36 that indicates transitioning the workload away from computing system 8A to another computing system 8B-8n would be advantageous for cost or for performance reasons.

FIG. 2C illustrates system 2 with workload 34 being rendered in solid lines and centered over, and connected to, provider 10B and thus to its corresponding public computing system 8B at time t₀+tₚ. to indicate that the workload has been transitioned to use computing system resources from public computing system 8B. Data 32 has not transitioned, or migrated, from storage 30. Rather, data 32 remains at storage 30 and ‘follows’ workload 34 without moving from storage 30 as the workload migrates from donor computing system 8A to recipient computing system 8B as shown by the broken line connecting enterprise data block 32 and enterprise workload 34 at the workload's new, or recipient, public computing system 8B.

It will be appreciated that during transition period 38, which may be a few minutes, a few seconds, or less than one second, workload 34 may not be serviced by computing resources of either computing system 8A or of computing system 8B. For transitioned workload 34 to resume operating on resources provided by computing system 8B, a pre-transition state, or pre-migration state, of the workload at time t₀ that may comprise settings, parameter values, instruction pointers, one or more steps of an application of the workload being executed, and the like, that existed before the transition from one computing system to the other began may be stored and transferred to new computing system 8B so that the transitioned workload can ‘pick up where it left off.’ The terms ‘pre-migration’ and ‘pre-transition’ may be used interchangeably, and the terms ‘migration’ and ‘transition’ may be used interchangeably.

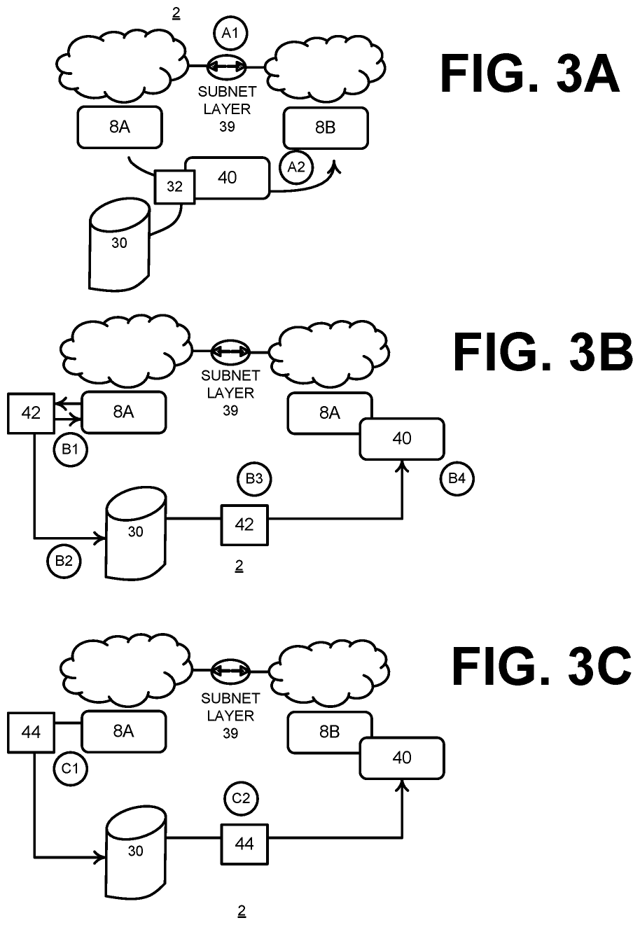

Turning now to FIG. 3A, the figure illustrates donor computing system 8A and recipient computing system 8B arranged for a full VM transfer. At step A1 subnet layer 39 connection between computing systems 8A and 8B may be established to facilitate transfer of one or more VMs 40 corresponding to enterprise 6 shown in previous figures from the current donor computing system 8A to the target recipient computing system 8B. After subnet layer connection 39 is established, VMs, which may include application code, may be transferred at step A2 via the subnet layer from computing system 8A to computing system 8B. It will be appreciated that after a transfer begins, the one or more VMs 40 being transferred may not be serviced by a computing system and thus may be viewed as ‘dormant’. It will be appreciated that data 32 and storage 30, as shown in FIG. 2A, 2B, or 2C, may be connected to, or coupled with, VM 40 at donor system 8A shown in FIG. 3A before a transfer, but connected to the VM in recipient system 8B after the transfer after which the recipient system facilitates execution of the VM.

It will be appreciated that in the case of a bare-metal computing system being migrated, it may not be physical components that are migrated from one location to another, but the use of computing components that may be transferred from one location to another, in which case item 40 in FIG. 3A may represent a configuration of a bare-metal server such that if donor bare-metal computing system 8A is to be transferred and instantiated at recipient, or target, computing system 8B, a configuration 40 representing a state of the donor system at the time of transfer maybe transferred to the recipient system and will be used to create on system 8B the bare metal server as it was running on system 8A when the configuration 40 was generated.

In FIG. 3B, at step B1 one or more pre-transition, or pre-migration, VM information state, or states, 42 corresponding to one or more VMs that were running on computing system 8A at time t₀ is/are stored to storage 30 at step B2. A VM 40 may comprise a shell of a VM as well as a shell of an application that will need to be revived at target/donor computing system 8B using information of the pre-transitions state 42, corresponding to time t₀, that is saved to storage 30.

Pre-transition state information 42 is transferred to computing system 8B from storage 30 at step B3 and one or more shell applications of VMs 40 are revived using the pre-transition state information 42 at step B4, which may occur at or about time t₀+tₚ. Pre-transition state information 42 may be referred to as ‘dirty-state’ information to indicate that although state information 42 was current as of time t₀ circumstances may change during tₚ, for example, data from sensors being monitored by a VM 40 at to, may change during tₚ. When a VM 40 is revived at step B4 using state information 42 stored at step B2, VM will be revived to the state it was in at time t₀ when it was actively operating on donor computing system 8A.

In FIG. 3C, pre-transition application image 44 corresponding to the state of a workload to be transferred at time t₀ is moved from a VM 40 running on donor computing system 8A at t₀ to storage 30 at step C1 and then at step C2 from storage 30 to the VM 40 at recipient computing system 8B. Instead of just storing pre-transition state information 42 to storage 30, a snapshot of a full VM, including an application, may be stored to storage 30 before beginning a transition of one or more VMs from computing system 8A to computing system 8B. After a new VM at recipient computing system 8B has been started its state that was current at time t₀ may be revived using pre-transition application state information 44, which may comprise an image, or snapshot, of an application running on computing system 8A at to that is to be revived at recipient computing system 8B. A revived VM 40 running on computing system 8B may need to gather information to update itself to be current as of to +tₚ. To facilitate moving application state information 44 of a full VM, application code may be written to facilitate moving only a minimum of modules of the application that are needed for the application to start in the VM 40 at computing system 8B. Thus, an application may be written so that application image 44 may use an amount of memory that only transfers essential information and data to facilitate the application being transferred to and run at donor computing system 8B and so that connections and scripts are updated in the donor computing system 8B. Such minimal, or ‘skinny’ code may optimize latency and cost in storing application image 44 to storage 30 and then to donor computing system 8B.

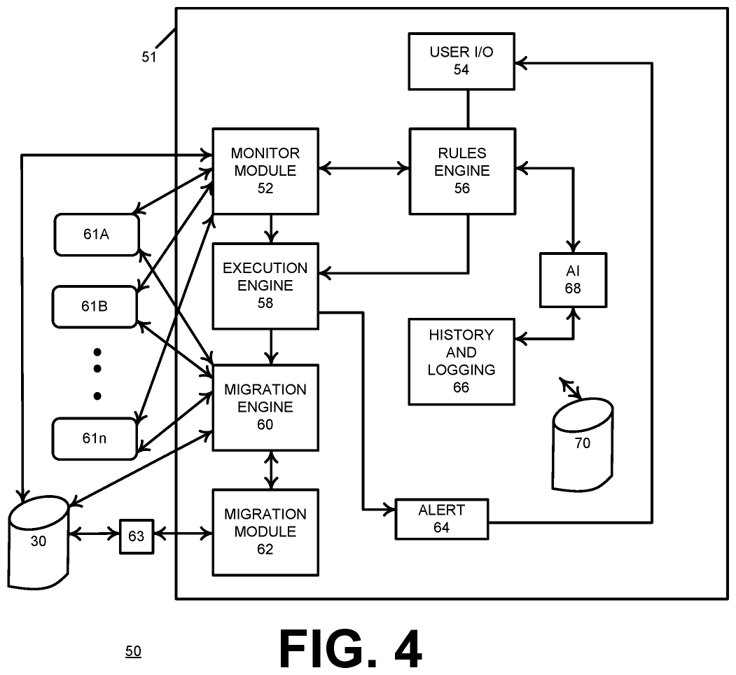

Turning now to FIG. 4, the figure illustrates a system 50, which may comprise a software module 51 that further comprises other software modules that may interface with external public or private clouds/computing systems. Module 51 may comprise service provider interfaces modules 61A-61n that correspond to public computing resource service providers 10A-10n as described in reference to other figures herein.

Module 51 may comprise monitor module 52. Monitor module 52 make comprise monitor 36 as shown in other figures herein, or may receive information from monitor 36 such as, for example, cost information related to computing resource providers 10A-10n. Monitoring module 52 may comprise a service that keeps track of a cost of holding and executing computational assets in the clouds of providers 10A-10n, and consuming cloud-based services. Monitoring module 52 may operate under control of policy rules engine 56, which may specify which assets and services to track (e.g., resources of cloud services providers 10A-10n, how often to monitor or sample, how to compute costs per application, user, or time, etc., and how or when to report monitored information.

Module 51 may include a user interface 54, which may provide a dashboard for a user, such as an employee of enterprise 6, as shown in FIG. 1, to use in evaluating, monitoring, establishing criteria, or reviewing of information relative to costs providers of public computing resources 10A-10n. a user may use user interface 54 to enter criteria that may be used to determine when to transition a workload from one public computing resources provider to another. The criteria may be forwarded to a rules engine module 56, which may apply the criteria, or other rules, to cost information received from monitor module 52. For example, a cost value corresponding to a public computing resources provider may be received by rules engine 56 from monitor module 52 and may cause rules engine 56 to change, or adapt, automatically, a criteria that a user may have entered using user interface module 54.

Rules engine module 56 may be programmed by the Financial Operations (“FinOps”) user of an enterprise using a policy specification language or other user interfaces via user interface module 54. Development Operations (“DevOps”) users of an enterprise may specify restrictions on policies, based on an application's requirements. Other types of users, in addition to FinOps or DevOps, may user interface 54 to program rules engine module 56. Rules engine module 56 may consider constraints, or criteria, and may create directives for the monitoring and reporting of cost information by a monitoring service facilitated by monitoring module 52. If the monitoring leads to determining threshold events that trigger actions, the set of actions may be directed by the rules engine module 56 to be performed by Policy/Action Execution Engine 58. The set of actions directed by rules engine 56 may comprise ‘recipes’, or programs, that execution engine 58 executes, under supervision and control of the rules engine 56.

Rules engine 56 may forward criteria, or other rules, that have been determined based on information received from user interface 54 or based on information received from module 52 to the execution engine module 58. Execution engine 58 may apply rules received from rules engine module 56 to cost information received from monitor module 52 and determine that a workload currently operating on a given public computing system should be migrated, partially or fully, to a different public computing system. Execution engine module 58 may forward a determination that a workload should be migrated, or transferred, from one public computing system to a different public computing system to migration engine module 60 to effectuate the migration, or transfer. Actions associated with workload asset and service migration from one public cloud to another, or to a private cloud, may be executed by execution engine module 58. Rules engine 56 may provide actions to be executed by execution engine 58 at run-time, or may be policies that were defined to rules engine 56 before the monitoring by a monitoring service facilitated by monitoring module 52 begins. Actions to be executed by execution engine 58 may change with time, or with external events, for example a cloud outage/computing system outage of one of service providers 10A-10n.

Migration engine module 60 may cause a snapshot of the workload or a current state of a VM running on the donor public computing system to be stored to storage 30. Migration module 62 may manage establishing a subnet layer between the donor computing system and the recipient computing system for the workload to be transferred it may retrieve the workload snapshot and state information from storage 30. Migration engine module 60 may combine and execute a logical program order for migration of cloud assets and services. Migration module 60 may also be involved in mapping the migration program parts into specific methods of migration/transfer of a workload, for example, a full VM transfer as described in reference to FIG. 3A, a dirty state transfer as described in reference to FIG. 3B, or an application state transfer as described in reference to FIG. 3C.

Migration module 62 may forward the VM state information and application snapshot information to the donor public computing system. Storage control module 63 may provide an interface with a public cloud-adjacent storage service, such as storage 30, such that migration module 62 interacts with module 63 without having to interface directly with storage 30. Similarly, other services can also be implemented, or ‘abstracted,’ using service-specific interfaces. Migration module 63 may map specific cloud actions (e.g., actions that are specific to, or customized with respect to, a given service provider's 10A-10n corresponding public computing system 8A-8n) to the respective cloud modules 61A-61n, and keep tracks of the migration control plane state, thus facilitating an atomic migration action for workload assets and services specified by rules engine 56. Atomicity facilitates completion of a migration/transition for a given computing system 8A-8n, or a return to the pre-migration/pre-transition state, but typically not partial execution of a migration/transition of a workload.

Alerting module 64 may manage an alerting function of system 50. Alerting module 64 may generate an alert message or cause an indication, either visual, audio, textual, and the like, to be provided to user interface 54. Alert module 64 may cause an alert at user interface 54 such that a user of the interface is either aware that a transfer from a donor public computing system to a recipient computing system will automatically occur, has automatically occurred, or that a manual confirmation from the user is required to effectuate the transfer from the donor public computing system to the recipient public computing system. Thus, DevOps and FinOps personnel can receive alerts of critical and emergency actions, as well as alerts based on the individual alerts/notification preferences of the personnel.

History and logging module 66 may comprise functionality to captures a history of activity in system 50, for example in a time-series database. A time-stamp record consisting of uniform log messages may be managed by module 66. A log may be forwarded to an external control-plane system, another log-capture service (e.g., a SIEM), etc. Management of logging settings, logging preferences, logging expectations, and other logging rules may be conducted by module 66.

History and logging module 66 may keep track of, log, or otherwise record transactions, such as, for example, cost information received by monitor module 52, input information provided to rules engine 56, user responses to alert messages, latency values associated with effectuating a transfer from one public computing resource to another upon a determination being made to do such a transfer, another transaction and information related to transferring a workload from one public computing system to another public computing system. History and logging information may be provided from history and logging module 66 to artificial intelligence module 68. Artificial intelligence module 68 may use information received from history and logging module 66 to revise a learning model that may automatically revise rules and criteria of rules engine 56 without further human intervention or without input received at rules engine 56 from user interface module 54. Storage 70, which may comprise a database, may keep track of overall operation of system 50, or module 51, and may comprise history and logging information generated by history and logging module 66, criteria in transactions related thereto received by rules engine module 56 from user interface 54, cost information received at monitor module 52 and provided to rules engine 56 or execution engine 58, or information related to migration, or transfer, of a workload, such as, for example, latency, time of day, time of week. Storage 70 may comprise relational and NoSQL database management systems, and provide atomicity, consistency, isolation, and durability (“ACID”) assurances. Storage 70 may maintain state information of the execution of system 51 with respect to transferring a workload from one public computing system to another, as well as provide failover, disaster recovery, and business continuity functionality.

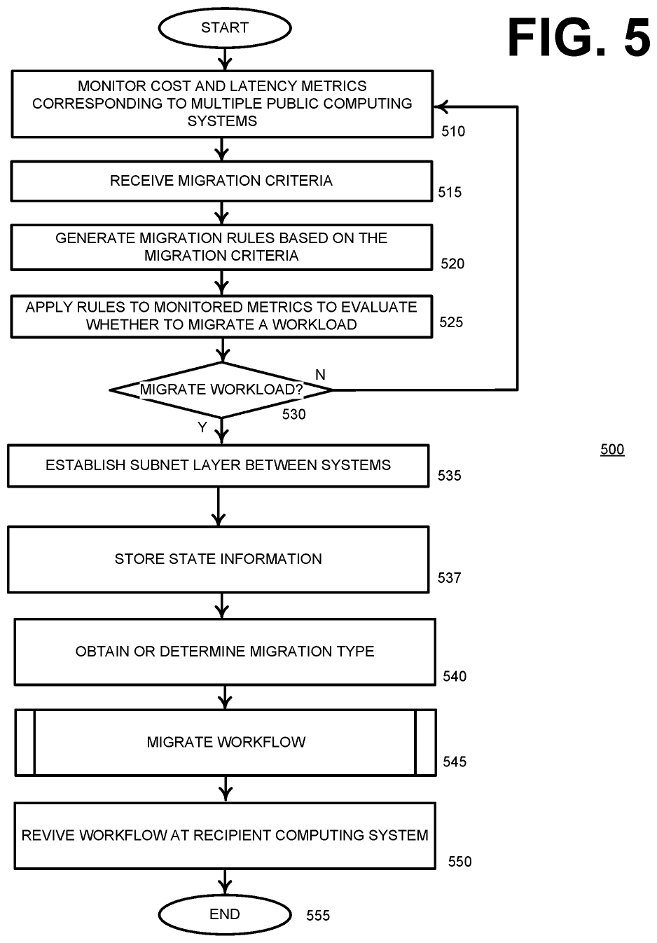

Turning now to FIG. 5, the figure illustrates a flow diagram of an embodiment method 500 to migrate a workload from a first public computing system to a second public computing system. Method 500 begins at step 505. At step 510 a module monitors cost metrics received from multiple computing systems. The cost metrics may correspond to pricing for computer resources offered by one or more public computing service providers. In addition, costs metrics may include pricing for use of public computing resources that have been sold by the operator of the public computing resources and are being resold. At step 515 migration criteria may be received from a user interface module. For example, a user, such as an Information Technology (“IT”) employee of an enterprise, may enter a criterion or criteria for when a workload that the enterprise is currently being facilitated by a public computing system should be migrated to a different public computing system. The criteria may be used to evaluate cost metrics received from one or more public computing systems or from a reseller market as described in reference to step 510. The criteria may also be used to evaluate latency relative to the public computing system that is currently being used to run the workload and a latency of another public computing system to which the workload may be migrated. The criteria may also be used to evaluate information relative to a transition period that may be associated with migrating the workload from the currently used public computing system to a different public computing system.

At step 520 migration rules are generated based on the migration criteria. At step 525 the rules that are based on the migration criteria received at step 515 are applied to the metrics monitored at step 510 to evaluate whether to migrate the workload from a public computing system currently being used to run the workload or to a different public computing system. At step 530, if a result of the evaluation made it step 525 is that the workload is not to be migrated method 500 returns to step 510 and metrics continued to be monitored.

If, however, a determination is made at step 530 that a result of the evaluation performed at step 525 is that the workload should be migrated from a public computing system that is currently being used to operate the workload to a different public computing system, method 500 advances to step 535. At step 535 a subnet layer connection may be established between the public computing system that is currently being used to operate the workload and a different public computing system to which the workload is to be migrated based on the evaluation made at step 525.

At step 537 state information corresponding to the workload may be stored to a remote storage that may be operated at a data center that is geographically located proximate to the public computing system that is currently being used to operate the workload or proximate a public computing system to which the workload is to be migrated. Although the remote storage may be located graphically close to the current, donor, public computing system or geographically close to the recipient computing system the remote storage may nevertheless be a separate storage and may be operated by a different service provider then a service provider of the donor computing system or the recipient computing system. In an embodiment, the state information that may be stored to the remote storage may comprise state information corresponding to the workload such that if a new virtual machine that is to continue the workload at the recipient computing system is to be established the state information may be used to revive the new workload virtual machine at the recipient computing system. In an embodiment, the state information that may be stored to the remote storage may comprise an image, or snapshot, of the current workload as it existed at the time performing step 537 such that instead of beginning a new virtual machine and then reviving the workload by applying stored state information to the new virtual machine, an image of the workload, which may include an application and its associated executable code, parameters, data, coefficients, algorithms, factors, and other aspects of the workload may be used to revive the workload at the recipient public computing system when the public computing system retrieves the image of the workload that is stored at step 537.

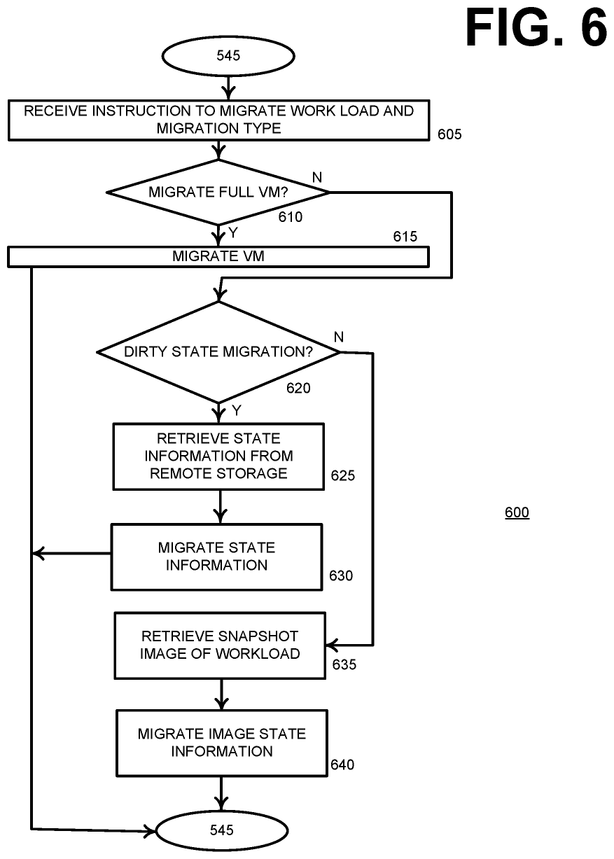

At step 540 a migration type, which may also be based on the evaluation performed at step 525, may be retrieved. At step 545 the workload may be migrated according to the migration type and according to a determination at step 525 of a public computing system to which the workload is to be migrated. A more detailed discussion of the migrating of the workload is provided in reference to FIG. 6. At step 550 the workload is revived as described above in reference to step 537 and is further described in reference to FIG. 6. Method 500 ends at step 555

turning now to FIG. 6, the figure illustrates a flow diagram of an embodiment method 545 to migrate a workload from a donor computing system to a recipient computing system, and to revive the workload at the recipient computing system. Method 545 begins at step 545 as described in reference to FIG. 5. At step 605 method 545 an execution module receives an instruction to migrate a workload from the donor computing system to the recipient computing system. The execution module may also receive a migration type, which may be to transfer the workload directly via a subnet layer between the donor computing system and the recipient computing system. The migration type may be a ‘dirty state’ transfer in which state information relative to the workload to be migrated has been stored to a remote storage but where a new virtual machine starts at the recipient computing system and is revived using the state information that is retrieved by the recipient computing system from the remote storage. The migration type may be an image migration where a snapshot is taken of the workload at the donor computing system before the migration begins and is stored to remote storage and then the recipient computing system retrieves the snapshot image of the workload and revives the workload based on the retrieved workload image.

At step 610 the execution module determines whether the migration type is to be a migration of a full virtual machine directly from the donor computing system to the recipient computing system. If the determination at step 610 is that a full VM migration is to be made, the workload is directly transferred via a subnet layer from the donor computing system to the recipient computing system in method 545 returns to step 545 as shown and described in reference to FIG. 5.

If a determination made it step 610 is that a full virtual machine migration is not to be made method 545 advances to step 620. At step 620 a determination is made whether a partial, or dirty state, migration is to be made. If a determination made at step 620 is that a dirty state migration is to be made method 545 advances to step 625. At step 625 the recipient computing system is instructed to retrieve from a remote storage state information corresponding to the workload that was stored at step 537 as described in reference to FIG. 5. At step 630 the recipient computing system may be instructed to begin a new virtual machine, retrieve dirty state information from the remote storage and revive the workload by executing the new virtual machine using the dirty state information retrieved from the remote storage. After step 630 method 545 returns to step 545 as described in reference to FIG. 5.

If a determination made at step 620 is that a dirty state migration is not to be made, method 545 advances to step 635. At step 635 the recipient computing system is instructed to read an image of the workload to be migrated from a remote storage. At step 640 the recipient computing system is instructed to revive the workload by running the workload based on the workload image retrieved at step 635 and method 545 returns to step 545 as described in reference to FIG. 5. A migration type, or a migration type instruction, may be determined manually by a user using interface 54, or a migration type may be determined automatically based complexity of a workload, how many connections or resources it may have to, or share with, other workloads, instances, application, processors, virtual machines, storage, and the like. If a workload is relatively simple with few external connections or interactions a determination may be made to perform a direct migration. For a complex workload with more connections a determination may be made that a migration type is to be a dirty state migration. A system such as system 50, or a module, such as module 52 may determine a given migration type according to information and data acquired from monitoring the current workload and interconnections therewith.

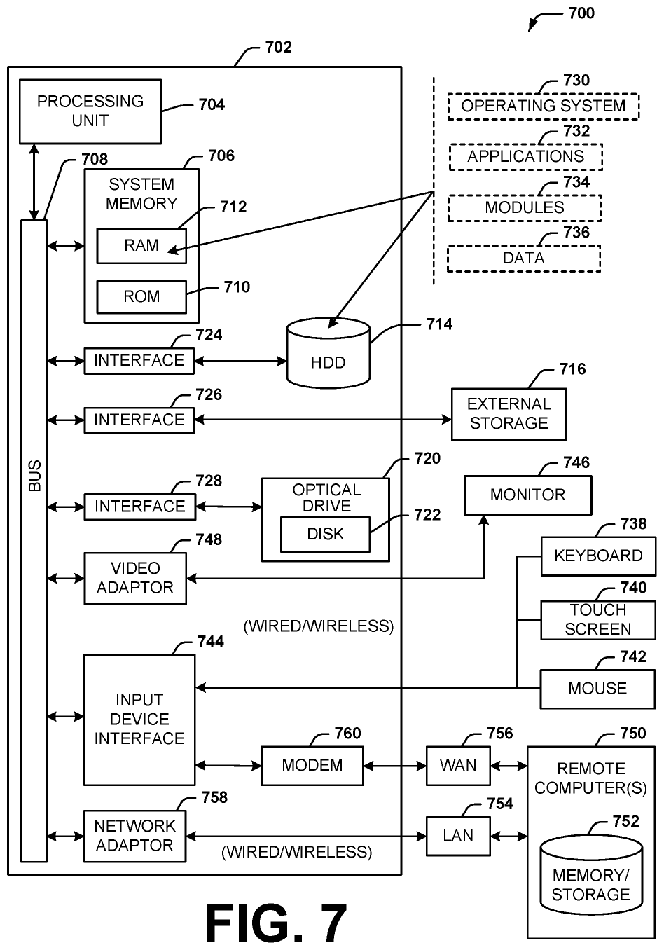

In order to provide additional context for various embodiments described herein, FIG. 7 and the following discussion are intended to provide a brief, general description of a suitable computing environment 700 in which various embodiments of the embodiment described herein can be implemented. While embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, IoT devices, distributed computing systems, as well as personal computers, hand-held computing devices, microprocessor-based or programmable consumer electronics, and the like, each of which can be operatively coupled to one or more associated devices.

The embodiments illustrated herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 7, the example environment 700 for implementing various embodiments of the aspects described herein includes a computer 702, the computer 702 including a processing unit 704, a system memory 706 and a system bus 708. The system bus 708 couples system components including, but not limited to, the system memory 706 to the processing unit 704. The processing unit 704 can be any of various commercially available processors and may include a cache memory. Dual microprocessors and other multi-processor architectures can also be employed as the processing unit 704.

The system bus 708 can be any of several types of bus structure that can further interconnect to a memory bus (with or without a memory controller), a peripheral bus, and a local bus using any of a variety of commercially available bus architectures. The system memory 706 includes ROM 710 and RAM 712. A basic input/output system (BIOS) can be stored in a non-volatile memory such as ROM, erasable programmable read only memory (EPROM), EEPROM, which BIOS contains the basic routines that help to transfer information between elements within the computer 702, such as during startup. The RAM 612 can also include a high-speed RAM such as static RAM for caching data.

Computer 702 further includes an internal hard disk drive (HDD) 714 (e.g., EIDE, SATA), one or more external storage devices 716 (e.g., a magnetic floppy disk drive (FDD) 716, a memory stick or flash drive reader, a memory card reader, etc.) and an optical disk drive 720 (e.g., which can read or write from a CD-ROM disc, a DVD, a BD, etc.). While the internal HDD 714 is illustrated as located within the computer 702, the internal HDD 714 can also be configured for external use in a suitable chassis (not shown). Additionally, while not shown in environment 700, a solid-state drive (SSD) could be used in addition to, or in place of, an HDD 714. The HDD 714, external storage device(s) 716 and optical disk drive 720 can be connected to the system bus 708 by an HDD interface 724, an external storage interface 726 and an optical drive interface 728, respectively. The interface 724 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 702, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 712, including an operating system 730, one or more application programs 732, other program modules 734 and program data 736. All or portions of the operating system, applications, modules, and/or data can also be cached in the RAM 712. The systems and methods described herein can be implemented utilizing various commercially available operating systems or combinations of operating systems.

Computer 702 can optionally comprise emulation technologies. For example, a hypervisor (not shown) or other intermediary can emulate a hardware environment for operating system 730, and the emulated hardware can optionally be different from the hardware illustrated in FIG. 7. In such an embodiment, operating system 730 can comprise one virtual machine (VM) of multiple VMs hosted at computer 702. Furthermore, operating system 730 can provide runtime environments, such as the Java runtime environment or the .NET framework, for applications 732. Runtime environments are consistent execution environments that allow applications 732 to run on any operating system that includes the runtime environment. Similarly, operating system 730 can support containers, and applications 732 can be in the form of containers, which are lightweight, standalone, executable packages of software that include, e.g., code, runtime, system tools, system libraries and settings for an application.

Further, computer 702 can comprise a security module, such as a trusted processing module (TPM). For instance, with a TPM, boot components hash next in time boot components, and wait for a match of results to secured values, before loading a next boot component. This process can take place at any layer in the code execution stack of computer 602, e.g., applied at the application execution level or at the operating system (OS) kernel level, thereby enabling security at any level of code execution.

A user can enter commands and information into the computer 702 through one or more wired/wireless input devices, e.g., a keyboard 738, a touch screen 740, and a pointing device, such as a mouse 742. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 704 through an input device interface 744 that can be coupled to the system bus 708, but can be connected by other interfaces, such as a parallel port, an IEEE 1394 serial port, a game port, a USB port, an IR interface, a BLUETOOTH® interface, etc.

A monitor 746 or other type of display device can be also connected to the system bus 608 via an interface, such as a video adapter 748. In addition to the monitor 746, a computer typically includes other peripheral output devices (not shown), such as speakers, printers, etc.

The computer 702 can operate in a networked environment using logical connections via wired and/or wireless communications to one or more remote computers, such as a remote computer(s) 750. The remote computer(s) 750 can be a workstation, a server computer, a router, a personal computer, portable computer, microprocessor-based entertainment appliance, a peer device or other common network node, and typically includes many or all of the elements described relative to the computer 702, although, for purposes of brevity, only a memory/storage device 752 is illustrated. The logical connections depicted include wired/wireless connectivity to a local area network (LAN) 754 and/or larger networks, e.g., a wide area network (WAN) 756. Such LAN and WAN networking environments are commonplace in offices and companies, and facilitate enterprise-wide computer networks, such as intranets, all of which can connect to a global communications network, e.g., the internet.

When used in a LAN networking environment, the computer 702 can be connected to the local network 754 through a wired and/or wireless communication network interface or adapter 758. The adapter 758 can facilitate wired or wireless communication to the LAN 754, which can also include a wireless access point (AP) disposed thereon for communicating with the adapter 758 in a wireless mode.

When used in a WAN networking environment, the computer 702 can include a modem 760 or can be connected to a communications server on the WAN 756 via other means for establishing communications over the WAN 756, such as by way of the internet. The modem 760, which can be internal or external and a wired or wireless device, can be connected to the system bus 708 via the input device interface 744. In a networked environment, program modules depicted relative to the computer 702 or portions thereof, can be stored in the remote memory/storage device 752. It will be appreciated that the network connections shown are example and other means of establishing a communications link between the computers can be used.

When used in either a LAN or WAN networking environment, the computer 702 can access cloud storage systems or other network-based storage systems in addition to, or in place of, external storage devices 716 as described above. Generally, a connection between the computer 702 and a cloud storage system can be established over a LAN 754 or WAN 756 e.g., by the adapter 758 or modem 760, respectively. Upon connecting the computer 702 to an associated cloud storage system, the external storage interface 726 can, with the aid of the adapter 758 and/or modem 760, manage storage provided by the cloud storage system as it would other types of external storage. For instance, the external storage interface 726 can be configured to provide access to cloud storage sources as if those sources were physically connected to the computer 702.

The computer 702 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

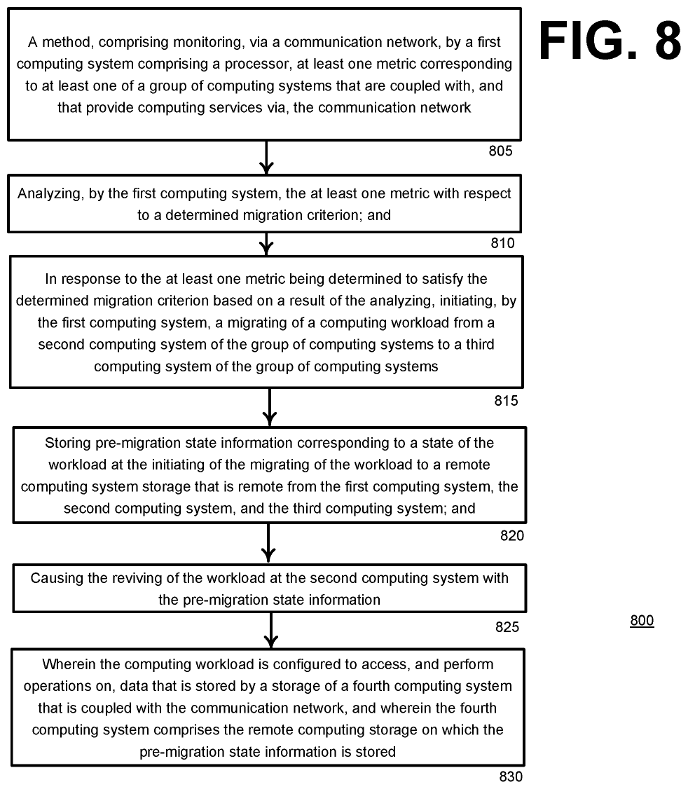

Turning now to FIG. 8, the figure illustrates an example method 800 comprising at block 805 a method, comprising monitoring, via a communication network, by a first computing system comprising a processor, at least one metric corresponding to at least one of a group of computing systems that are coupled with, and that provide computing services via, the communication network; at block 810 analyzing, by the first computing system, the at least one metric with respect to a determined migration criterion; and at block 815 in response to the at least one metric being determined to satisfy the determined migration criterion based on a result of the analyzing, initiating, by the first computing system, a migrating of a computing workload from a second computing system of the group of computing systems to a third computing system of the group of computing systems. Embodiment method 800 may further comprise at block 820 storing pre-migration state information corresponding to a state of the workload at the initiating of the migrating of the workload to a remote computing system storage that is remote from the first computing system, the second computing system, and the third computing system; and at block 825 causing the reviving of the workload at the second computing system with the pre-migration state information. Embodiment method 800 may further comprise at block 830 wherein the computing workload is configured to access, and perform operations on, data that is stored by a storage of a fourth computing system that is coupled with the communication network, and wherein the fourth computing system comprises the remote computing storage on which the pre-migration state information is stored.

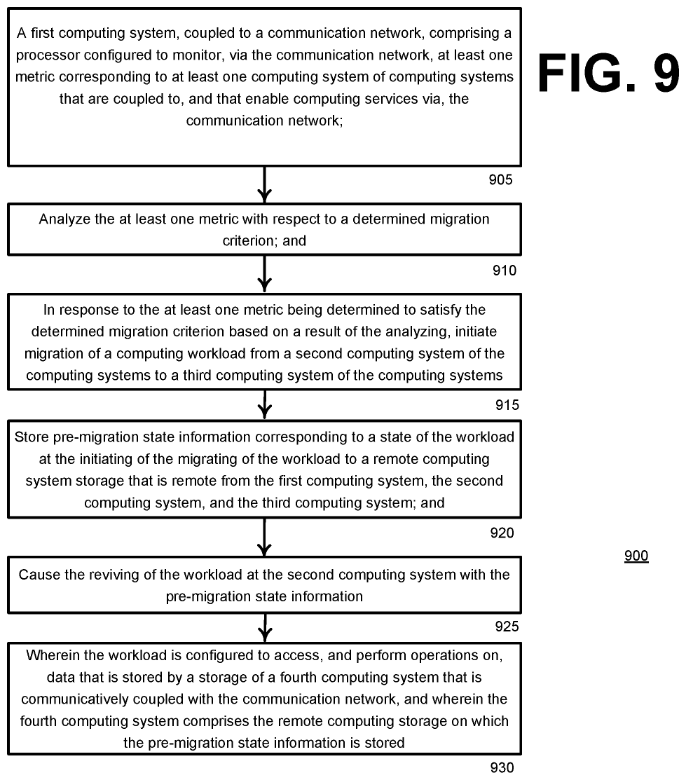

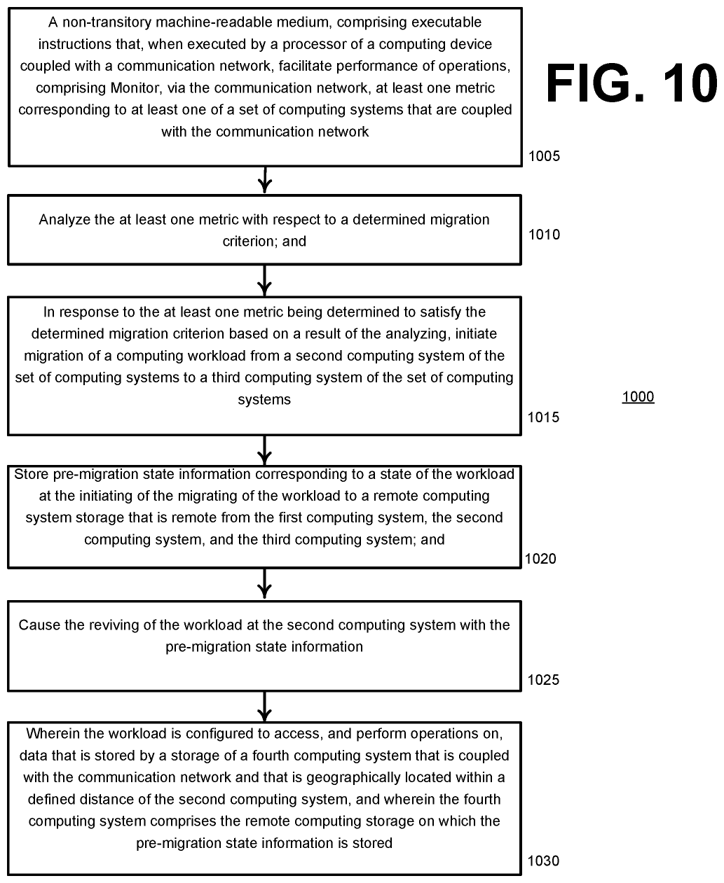

Turning now to FIG. 9, the figure illustrates am example system 900, comprising at block 905 a computing system comprising a processor configured to at block 905 monitor, via the communication network, at least one metric corresponding to at least one computing system of computing systems that are coupled to, and that enable computing services via, the communication network; at block 910 analyze the at least one metric with respect to a determined migration criterion; and at block 915 in response to the at least one metric being determined to satisfy the determined migration criterion based on a result of the analyzing, initiate migration of a computing workload from a second computing system of the computing systems to a third computing system of the computing systems. The processor may be further configured to at block 920 store pre-migration state information corresponding to a state of the workload at the initiating of the migrating of the workload to a remote computing system storage that is remote from the first computing system, the second computing system, and the third computing system; and at block 925 cause the reviving of the workload at the second computing system with the pre-migration state information. In addition, at block 930 the workload may be configured to access, and perform operations on, data that is stored by a storage of a fourth computing system that is communicatively coupled with the communication network, and the fourth computing system may comprise the remote computing storage on which the pre-migration state information is stored.

Turning now to FIG. 10, the figure illustrates a method 1000 comprising at block 1005 a non-transitory machine-readable medium, comprising executable instructions that, when executed by a processor of a computing device coupled with a communication network, facilitate performance of operations, comprising at block 1005 monitor, via the communication network, at least one metric corresponding to at least one of a set of computing systems that are coupled with the communication network; at block 1010 analyze the at least one metric with respect to a determined migration criterion; and at block 1015 in response to the at least one metric being determined to satisfy the determined migration criterion based on a result of the analyzing, initiate migration of a computing workload from a second computing system of the set of computing systems to a third computing system of the set of computing systems. The executable instructions may facilitate performance of operations by the processor further comprising at block 1020 store pre-migration state information corresponding to a state of the workload at the initiating of the migrating of the workload to a remote computing system storage that is remote from the first computing system, the second computing system, and the third computing system; and at block 1025 cause the reviving of the workload at the second computing system with the pre-migration state information. The executable instructions may facilitate performance of operations by the processor wherein at block 1030 the workload is configured to access, and perform operations on, data that is stored by a storage of a fourth computing system that is coupled with the communication network and that is geographically located within a defined distance of the second computing system, and wherein the fourth computing system comprises the remote computing storage on which the pre-migration state information is stored.

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above-described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” or variations thereof as may be used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
monitoring, via a communication network, by a first computing system comprising a processor, at least one metric corresponding to at least one of a group of computing systems that are coupled with, and that provide computing services via, the communication network;
analyzing, by the first computing system, the at least one metric with respect to a determined migration criterion; and
in response to the at least one metric being determined to satisfy the determined migration criterion based on a result of the analyzing, initiating, by the first computing system, a migrating of a computing workload from a second computing system of the group of computing systems to a third computing system of the group of computing systems.

2. The method of claim 1 further comprising storing pre-migration state information corresponding to a state of the workload at the initiating of the migrating of the workload to a remote computing system storage that is remote from the first computing system, the second computing system, and the third computing system; and
causing the reviving of the workload at the second computing system with the pre-migration state information.

3. The method of claim 1, wherein the computing workload comprises a computing instance.

4. The method of claim 2, wherein the computing workload is configured to access, and perform operations on, data that is stored by a storage of a fourth computing system that is coupled with the communication network, and wherein the fourth computing system comprises the remote computing storage on which the pre-migration state information is stored.

5. The method of claim 1, wherein the determined migration criterion is determined according to rules and factors.

6. The method of claim 5, wherein the rules and factors are determined based on user input received by the first computing system, and wherein the user input comprises information corresponding to the rules and factors via an interface coupled with the first computing system.

7. The method of claim 5, further comprising determining, by the first computing system, the rules and factors based on a log of migration operations performed by the first computing system before the analyzing of the at least one metric with respect to the determined migration criterion.

8. The method of claim 1, wherein the at least one metric comprises a spot market cost factor applicable to operation of the computing resource on the second computing system.

9. The method of claim 1, further comprising outputting, by the first computing system via a user interface of the first computing system, an alert that the at least one metric has been determined to satisfy the determined migration criterion.

10. A system, comprising:
a first computing system, coupled to a communication network, comprising a processor configured to:
monitor, via the communication network, at least one metric corresponding to at least one computing system of computing systems that are coupled to, and that enable computing services via, the communication network;
analyze the at least one metric with respect to a determined migration criterion; and
in response to the at least one metric being determined to satisfy the determined migration criterion based on a result of the analyzing, initiate migration of a computing workload from a second computing system of the computing systems to a third computing system of the computing systems.

11. The system of claim 10, wherein the processor is further configured to:
store pre-migration state information corresponding to a state of the workload at the initiating of the migrating of the workload to a remote computing system storage that is remote from the first computing system, the second computing system, and the third computing system; and
cause the reviving of the workload at the second computing system with the pre-migration state information.

12. The system of claim 11, wherein the workload is configured to access, and perform operations on, data that is stored by a storage of a fourth computing system that is communicatively coupled with the communication network, and wherein the fourth computing system comprises the remote computing storage on which the pre-migration state information is stored.

13. The system of claim 10, wherein the determined migration criterion is determined according to rules and factors.

14. The system of claim 13, wherein the processor is further configured to present a user interface to receive one or more inputs from a user to determine the rules and factors.

15. The system of claim 14, wherein the processor is further configured to determine the rules and factors based on a log of migration operations performed by the first computing system before the analyzing of the metric with respect to the determined migration criterion.

16. A non-transitory machine-readable medium, comprising executable instructions that, when executed by a processor of a computing device coupled with a communication network, facilitate performance of operations, comprising:
monitor, via the communication network, at least one metric corresponding to at least one of a set of computing systems that are coupled with the communication network;
analyze the at least one metric with respect to a determined migration criterion; and
in response to the at least one metric being determined to satisfy the determined migration criterion based on a result of the analyzing, initiate migration of a computing workload from a second computing system of the set of computing systems to a third computing system of the set of computing systems.

17. The non-transitory machine-readable medium of claim 16, wherein the processor is further configured to:
store pre-migration state information corresponding to a state of the workload at the initiating of the migrating of the workload to a remote computing system storage that is remote from the first computing system, the second computing system, and the third computing system; and
cause the reviving of the workload at the second computing system with the pre-migration state information.

18. The non-transitory machine-readable medium of claim 17, wherein the workload is configured to access, and perform operations on, data that is stored by a storage of a fourth computing system that is coupled with the communication network and that is geographically located within a defined distance of the second computing system, and wherein the fourth computing system comprises the remote computing storage on which the pre-migration state information is stored.

19. The non-transitory machine-readable medium of claim 17, wherein the pre-migration state information comprises an image of the workload.

20. The non-transitory machine-readable medium of claim 17, wherein the pre-migration state information comprises state information corresponding to the workload but is not an image of the workload.
